(19) United States
(12) Patent Application Publication
(10) Pub. No.: US 2026/0210477 A1
(43) Pub. Date: Jul. 23, 2026

(54) FLUID LEAK CORRECTING DEVICE

(71) Applicant: International Business Machines Corporation, Armonk, NY (US)

(72) Inventors: Vinod Anandram Valecha, Pune (IN); Jagabondhu Hazra, Bangalore (IN); Sarbajit Kumar Rakshit, Kolkata (IN); Manikandan Padmanaban, Chennai (IN)

(21) Appl. No.: 19/026,764

(22) Filed: Jan. 17, 2025

(51) Int. Cl. F16L 55/163; F16L 55/40; G01M 3/28

(52) U.S. Cl. CPC F16L 55/163; F16L 55/40; G01M 3/2815

(57) ABSTRACT

A device includes multiple segments interconnected via a plurality of articulating joints. At least one segment includes a vacuum cap. The vacuum cap has a curved sheet of a first flexible material, a flexible membrane, a region defined between the curved sheet of the first flexible material and the flexible membrane, and a pump configured to evacuate the region. A controller is controllably coupled to the plurality of segments and the pump. The controller is configured to navigate the device to a leak, position the vacuum cap on the leak and engage the vacuum cap.

### BACKGROUND

The present invention generally relates to correcting fluid leakage, and more specifically to a device for identifying, detecting and correcting fluid leaks.

In industrial environments various types of fluid leakages can occur leading to environmental concerns and operational inefficiencies. Depending on where a leak is located, and the environment that the leak is contained within it can be difficult to quickly identify the precise location of the leak. Furthermore, even once the location is identified fixing the leak may require the utilization of specialized equipment that is not readily available. As a result, the leak and any associated outages may persist.

### SUMMARY

Embodiments of the present invention are directed to a fluid leak correcting device. A non-limiting example of the computer-implemented method includes …

Embodiments of the invention are directed to a system for identifying a leak using a device employing an artificial intelligence based detection process. A non-limiting example of the device includes multiple segments interconnected via a plurality of articulating joints. At least one segment includes a vacuum cap. The vacuum cap has a curved sheet of a first flexible material, a flexible membrane, a region defined between the curved sheet of the first flexible material and the flexible membrane, and a pump configured to evacuate the region. A controller is controllably coupled to the plurality of segments and the pump. The controller is configured to navigate the device to a leak, position the vacuum cap on the leak and engage the vacuum cap.

Additional embodiments of the invention are directed to a method for operating the same.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts one exemplary cloud computing system configured to implement the system and method according to one embodiment;

FIG. 2A depicts an exemplary segmented leak detection and correction device;

FIG. 2B depicts a zoomed portion of the segmented leak detection and correction device of FIG. 2A;

FIG. 2C illustrates a cross sectional view of select features of a suction cap included on the segmented leak detection and correction device of FIG. 2A;

FIG. 3 depicts stages of identification of a leak using the segmented leak detection and connection device of FIG. 2; and

FIG. 4 depicts a process correcting a leak using the segmented leak detection and correction device of FIG. 2.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ± 8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Computing environment 100 contains an example of an environment for the execution of at least some of the computer code involved in performing the inventive methods, such detecting and identifying leaks at block 150. In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 132. Public Cloud 105 includes gateway 130, Cloud orchestration module 141, host physical machine set 142, virtual machine set 143, and container set 144.

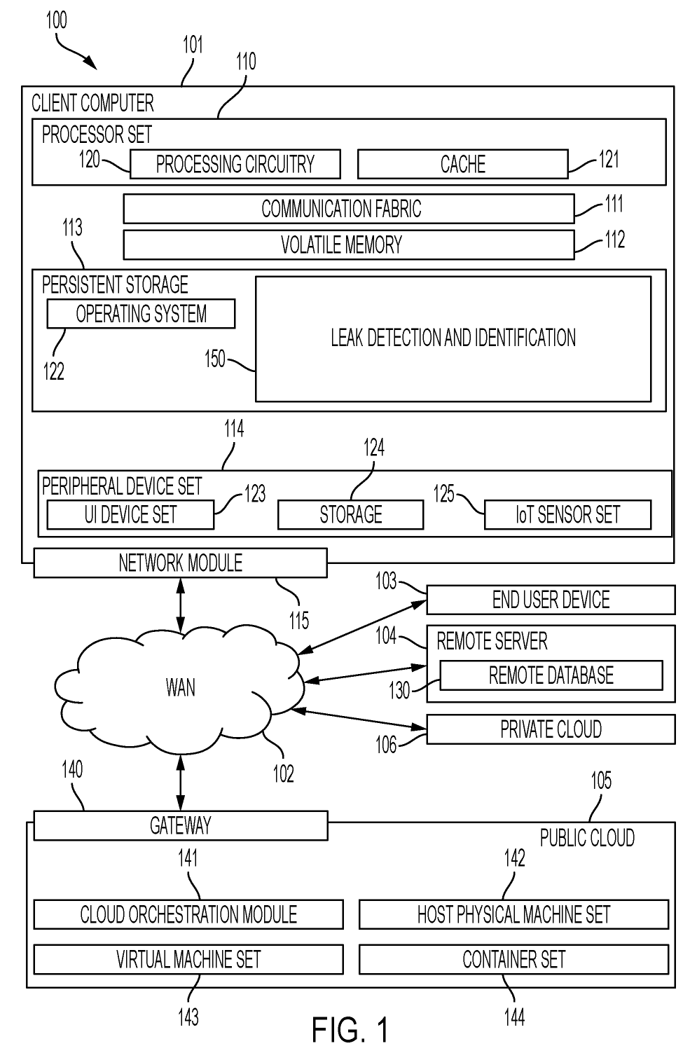

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 141. The computing resources provided by public Cloud 105 are typically implemented by virtual computing environments that run on various computers making up the computers of host physical machine set 142, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network’s designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Turning now to an overview of technologies that are more specifically relevant to aspects of the invention, in industrial settings, various types of leaks can occur, leading to potential environmental concerns and operational inefficiencies. Types of industrial leaks can include fluid leaks, oil and fuel spills, gas leaks, chemical leaks, steam leaks, refrigerant leaks, water leaks, vacuum leaks, electrical leaks, radiation leaks, and the like. When the leaks occur in an industrial setting, or at locations where it is otherwise difficult to safely access and work on the components including the leak, it can take substantial amounts of time before the leak can be mitigated and corrected.

In some cases, it is possible to shut down a system including the leak, thereby preventing further damage or contamination resulting from the leak. However, shutting down the system including the leak carries with it further operational inefficiencies as the system cannot perform designated functions while shut down. Exacerbating the difficulties associated with identifying the location of a leak is the fact that in some circumstances, once the location of the leak has been identified it may still remain difficult to fix the leak or prevent further leaking due to access difficulties, lack of readily available tools, and the like.

It is important for industrial facilities to utilize robust monitoring systems, regular inspections, and preventative maintenance practices to detect and address any potential leakages promptly, before they become severe.

Due to the disparate nature of industrial environments, there can be many different types of leakages and in some cases the leakage may not even be apparent until an investigation into a symptom of the leakage (e.g., an investigation of a pressure drop) is undertaken.

Turning now to an overview of the aspects of the invention, one or more embodiments of the invention address the above-described shortcomings of the prior art by providing a segmented device equipped with sensors for identifying a location of a leakage and equipped with vacuum suction caps able to be fitted over a leak, thereby allowing the leak to be temporarily patched until a full repair is completed. The segmented device can further be in communication with a larger computer system and machine learning (ML) systems may be implemented to identify the location and type of a leak based on a combination of the local sensors of the segmented device and remote sensors disposed about an industrial environment. In yet further examples, the segmented device can be equipped to supplement the leak stopping ability of the suction cap via a constriction of the device itself about the pip, or other feature, that is leaking.

The above-described aspects of the invention address the shortcomings of the prior art by providing a system and component able to identify and temporarily correct a leak in an industrial environment using the segmented device, thereby allowing the system including the leaking component to maintain functionality until a full repair is able to be performed.

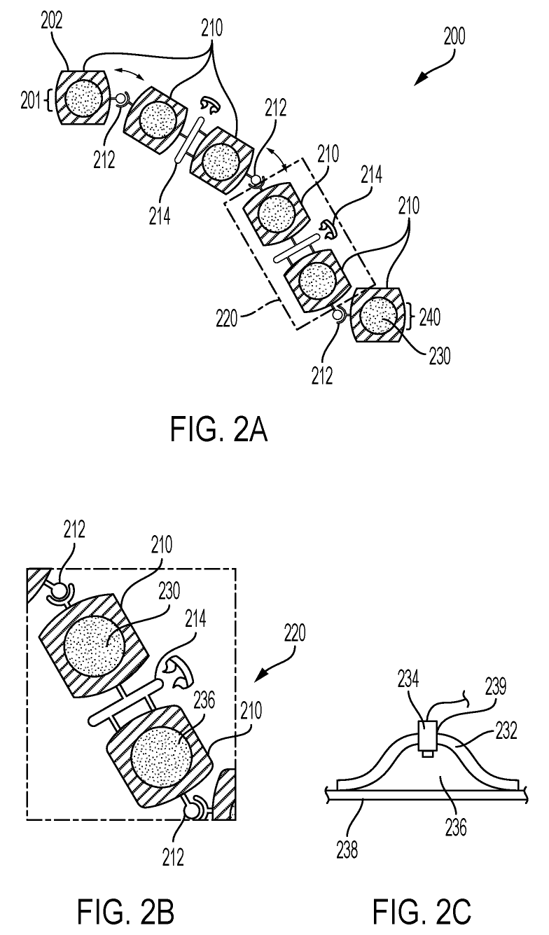

Turning now to a more detailed description of aspects of the present invention, FIG. 2A depicts a bottom surface of a segmented leak detection and correction device (segmented device 200) according to some embodiments. The segmented device 200 is constructed of multiple segments 210. A close view of a pair 220 of segments 210 is illustrated in FIG. 2B, and a schematic view of select features of a vacuum cap mounted to the segments 210 is illustrated in FIG. 2C.

Each segment 210 is connected to another segment 210 via a corresponding joint 212, 214. The joints 212, 214 are able to be articulated in different planes, with a first set of joints 212 being able to be articulated within the plane of the illustration, and the second set of joints 214 being able to be articulated perpendicular to the plane of the image. Mechanical structures for the joints 212, 214 and electromechanical controls for the joints 212, 214 may be constructed according to any configuration and are within the skill in the art.

Each segment 210 includes a vacuum cap 230 (select features of which are illustrated in greater detail in FIG. 2C) disposed on the bottom surface 202. The vacuum caps 230 are curved sheets 232 of a flexible material that form a dome shape. Each vacuum cap 230 includes a pump 234 controlled by a controller of the segmented device 200. In the illustrated example, the pump 234 is positioned at an apex 239 of the curved sheet 232. In alternated implementations the pump 234 may be positioned in alternate locations. When the pump 234 is engaged, a vacuum is created in a region 235 under the curved sheet 232. A flexible membrane 238 is positioned on an opposite end of the region 235 and seals the region 235. Engaging the pump 234 creates a vacuum within the region 236, drawing the flexible membrane 238 toward an apex 239 of the vacuum cap 230. This, in turn, creates a suction force between the flexible membrane 238 and any surface contacting the flexible membrane 238 (e.g., a pipe surface). The segmented device 200 may include a controller 201 for controller operations of the segmented device 200 and interpreting signals from a sensor suite 240. In alternate examples, the segmented device 200 may replace the controller 201 with a continuous connection (e.g. a wireless connection) to a central computer system, such as the client computer 101 of FIG. 1.

By positioning the suction cap 230 over a leak, when the opening (e.g., crack) causing the leak is smaller than the size of the vacuum cap 230, and engaging the pump 234, the vacuum cap 230 forms a seal around the leak, and continued leakage is prevented as long as the force of the leak is less than the strength of the vacuum cap 230.

In the example segmented device 200 of FIGS. 2A, 2B and 2C, a vacuum cap 230 is included on each segment 210. In alternative examples, less than all of the segments 210 may include the vacuum caps 230 as long as at least one segment 210 includes a vacuum cap 230.

In another example segmented device 200, the vacuum caps 230 can include caps having varying dimensions and vacuum powers, and a segmented device 200 controller controlling the segmented device 200 can select an appropriate size, and power, vacuum cap 230 based on detected or calculated parameters of the leak.

In addition to the vacuum caps 230, the segmented device 200 includes a sensor suite 240. The sensor suite 240 can include an image sensor, an audio sensor, pressure sensors, temperature sensor, flow sensor and the like. In some examples, the segmented device 200 further includes wireless communications with a central computer system, such as through the WAN 102 allowing the segmented device 200 to offload some processing and allowing the segmented device 200 to have access to additional environmental sensors that may be distributed throughout the environment, and to have access to sensors and monitoring data of the equipment being checked for leaks.

In some examples, where the force of the leak exceeds the vacuum power of the suction caps 230, and where the segmented device 200 is sufficiently long to warp around a pipe or other fixture having the leak, the force of the vacuum cap 230 can be supplemented by a constricting force using the articulating joints 212, 214 to effectively clamp the segmented device 200 around the pipe or other fixture. The constriction force is a force directed toward a center of the pipe or other feature and generated by constricting the segmented device 200 about the pipe or other feature. In such an example the total sealing force is a combination of the available constriction force of the segmented device 200 and the suction force available from the vacuum cap 230.

In yet another example, the joints 212, 214 of the segmented device 200 may be disconnect able, allowing a portion of the segmented device 200 to disconnect and return to a home base while leaving a portion behind to maintain the temporary seal.

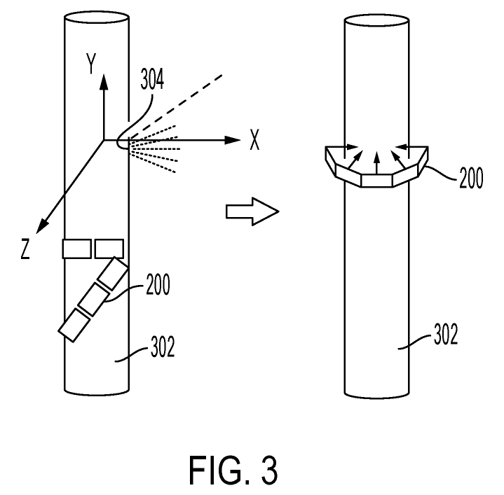

With continued reference to FIGS. 1-2C, FIG. 3 illustrates an example operation of the segmented device 200 as the segmented device 200 traverses a pipe 302 to identify a location of a leak 304 on the pipe 302. Upon reaching the location of the leak 304, the segmented device 200 wraps around the leak 304, positioning one of the vacuum caps 230 (illustrated in FIGS. 2A-2C) over the leak 304 such that the entirety of the leak 304 is within a circumference of the vacuum cap 230. The segmented device 200 then engages the positioned vacuum cap 230 and constricts, temporarily sealing the leak 304.

In one specific example, and with continued reference to FIGS. 1-3, the vacuum cap 230 is a small, flexible cap that is attached to a surface of a segment of the segmented device 200. The vacuum cap 230 has a flexible membrane 238 that creates a vacuum seal when air is removed from a region 236 inside of the vacuum cap 230. The vacuum seal is created by using a suction pump 234, which removes air from the inside of the vacuum cap 230. The vacuum cap 230 is made of a durable material that can withstand the expected forces of a leak. The vacuum cap 230 is also flexible enough to conform to the shape of the leak and/or the shape of the pipe 302 or other surface that the leak is on.

In one example, the dimension and shape of the vacuum cap 230 are similar to one segment 210 of the segmented device 200 and the vacuum cap 230 fills a majority of the segment 210.

In further examples, the controller 201 of the segmented device 200 is configured to identify the criticality of the leak by analyzing the leak using sensors within the sensor suite 240 and/or environmental sensors in communication with the segmented device 200. The criticality of the leak can be determined based on the type of leakage, the force of the leakage, and the impact of the leak and/or fluid to the surrounding environment.

In some examples, a machine learning (ML) system, such as a neural network, is used to detect the leak and to calculate a counterforce required to stop the leak. In one example, the ML algorithm utilized is a convolutional neural networks (CNNs). The CNN is trained on labeled data to recognize patterns and characteristics of different types of leaks. In such an example, the ML model is trained using environmental data of the industrial environment in which the segmented device 200 will be deployed (physical testing) as well as through simulations such as intentionally created leaks at a similar pressure and of a similar type of fluid, temperature, etc. as those that are likely to be encountered. Using this data, a machine learning model is created and validated, and the machine learning model is then used by the segmented device to generate leak detection and force calculation algorithms.

In a practical implementation, the ML model is integrated with multiple sensor types, including acoustic sensors, pressure sensors, and temperature sensors, to detect and analyze the characteristics of the leak. These sensors can be attached to the segmented device 200 as part of the sensor suite 240 or distributed around the industrial floor and in communication with the segmented device 200. Raw sensor data from the sensors is processed and filtered to extract relevant features. The raw sensor data is processed using signal processing techniques including wavelet transforms, bandpass filtering, and spectrogram analysis to extract features corresponding to the sensor type. The features can include frequency, amplitude, duration of the leak and any other features available from the raw data and are used to identify the type of leak that is present (e.g. what fluid is leaking, and what the characteristics of that fluid are).

Once the type of leak has been identified, the ML model calculates the force required to stop the leak using a combination of physical laws, such as Bernoulli's principle and fluid mechanics, and the machine learning algorithm. The ML model uses the characteristics of the leak, such as flow rate, pressure, and location, to estimate the force required. The ML estimate and the determination using physical laws are combined in a weighted average, to determine an amount of force required to be applied to seal the leak.

The ML model additionally provides real-time feedback to the segmented device 200 regarding the efficacy of the seal, thereby allowing the segmented device 200 to adjust the position and force application of the segmented device 200. The feedback is used to optimize the placement of the vacuum cap 230 and/or to determine if any additional force is required to maintain the temporary seal.

In one example, the ML model is integrated with the segmented device 200 and enables real-time leak detection and force calculation via a wireless connection with a wide area network (WAN 102). In such an example, the segmented device 200 includes conventional hardware and software to communicate with the ML model through the WAN 102 and converts and output of the ML model to a command to apply the appropriate force to the vacuum cap 230.

In some examples, the ML model is continually updated and retrained to adapt to new types of leaks and changes in the industrial environment. This can be accomplished through a feedback loop that stores new data as the segmented device 200 is operated and incorporates the new data and performance metrics into the ML training data set.

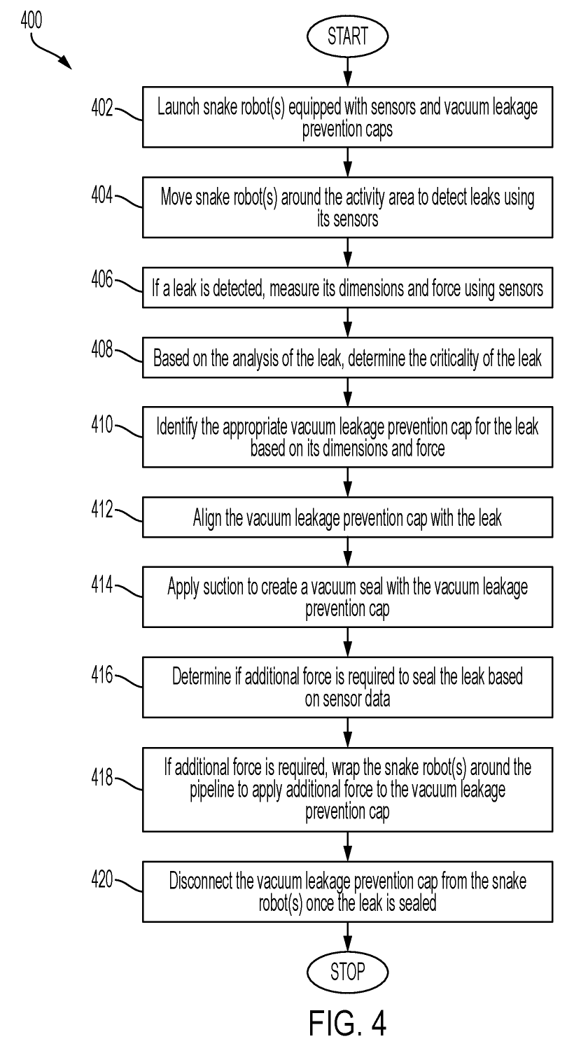

With continued reference to FIGS. 1-3, FIG. 4 illustrates an example process 400 for operating the segmented device 200 of FIG. 2 to identify and repair a leak 304.

Initially, the process 400 launches a segmented device 200 equipped with any sensors appropriate for the industrial environment in which the segmented device 200 will be operating in a launch step 402. In some examples, the launch step 402 can include selecting a number of segments 210 for the segmented device 200 based on an expected required length of the segmented device 200. The expected required length can be determined by one of skill in the art based on prior experience, based on an expected diameter of the largest pipe or feature that may need traversing, or using any other criteria.

After launching, the segmented device 200 is navigated around the industrial environment where the leak is expected, and the sensors in the sensor suite 240 are employed to detect indicators of a leak in a navigate device step 404. When indicators of a leak 304 are detected, the segmented device 200 moves toward the leak until the location of the leak 304 is identified.

Upon detecting the location of the leak 304, the segmented device 200 determines the dimensions (physical area) of the opening allowing the leak 304, and the force at which fluid is exiting the opening allowing the leak 304.

In one example, the force of the leak is determined by initially measuring the velocity of the leaking fluid. The velocity of the leaking fluid is V and is detected by sensors in the sensor suite 320 of the segmented device 200. The velocity is typically measured in meters per second (m/s), although any appropriate units may be used depending on the environment in which the segmented device 200 is being employed.

The segmented device 200 also estimates a dimension (e.g., longest length) and cross-sectional area of the detected leak 304. Based on detected closed loop contour of the leak 304, the segmented device 200 calculates an area (A) of the opening causing the leak 304. In one example, the segmented device 200 can use image analysis of an imaging sensor in the sensor suite 340 to detect the area of the leak 304. In one example, the area of the leak 304 is measured with unit square meters (m²), although in alternate examples any other appropriate units may be utilized.

As the fluid is flowing through the pipe 302, the segmented device 200 determines the density of the fluid based on fluid specifications learned using a networked connection to and industrial system including the pipe 302. The segmented device 200 also determines the physical state of the fluid (e.g., liquid, gas, etc.). The density of the fluid is a function of temperature and the applied pressure. The base density (ρ) of the fluid for any defined state is gathered from the density graph in the fluid specification. The density is typically measured in kilograms per cubic meter (kg/m³). As the fluid is flowing through the pipe, leaking fluid has same density at the opening of the leak 304 as the fluid flowing through the pipe 302.

By applying Bernoulli's principle to calculate the sum of pressure energy, kinetic energy, and potential energy per unit, a volume of fluid is constant along a streamline. Bernoulli's equation can be written as: P + 0.5 * ρ * V^2 = constant, where: P is the pressure of the fluid (in pascals, Pa) ρ is the density of the fluid (in kg/m³) V is the velocity of the fluid (in m/s). The value of the constant is calculated by the pressure gauge with the pipe, which is measured by a flow meter.

The segmented device 200 calculates the force (F) exerted by the leaking fluid at the opening of the leak 304 by multiplying the pressure (P) at the leak 304 by the area (A) of the leak 304 according to F = P * A.

When image sensing (e.g., via a camera) is available, a direction of the fluid leaking out the leak 304 can be determined by capturing the area of the pipe 302 where the fluid is leaking within the image. The image sensor can be included within the sensor suite 340 of the segmented device 200. Alternately the image sensor can be a camera in the surrounding environment accessible to the segmented device 200 through a WAN 102. In some examples, the imaging sensor provides a real-time streaming camera feed and/or periodic still snapshots. Sequential images and/or periodic snapshots provide a continuous visual representation of the leaking fluid, and the how the fluid is spreading or spraying from the leak 304. Computer visions techniques allow the segmented device 200 to analyze the movement and behavior of the fluid (e.g., spraying out at an arc, rolling down the pipe 302, etc.). The analysis can include detecting and tracking the fluid flow, identifying flow boundaries, and estimating a velocity and direction of the fluid flow. Using the direction of the forces generated by the fluid, the relative direction of different types of flowing fluid from the leak 304 are identified, as well as the direction of the flowing fluid speed.

In some examples, the fluid can be coming out of the opening creating the leak 304 at multiple directions. In such examples, the force is calculated in all directions to determine a single resultant force vector according to Resultant Force (FR) = √(Fx^2 + Fy^2 + Fz^2), where FR represents the magnitude of the resultant force and Fx, Fy, and Fz are individual force components in x, y, and z directions, respectively. To calculate the resultant force, the segmented device 200 identifies the individual force components of each identifiable spray and determines the magnitudes of the force components of each identifiable spray acting in each axis (x, y, and z). These components represent forces exerted by different sources or forces acting at different angles the components of each identifiable spray are added together and the resultant force (FR) provides the overall force acting in the 3D space. The resultant force vector provides information about the combined effect of the individual force components in different directions and assists the segmented device 200 in defining a necessary counter force by wrapping around the leak area (discussed in more detail with regards to step 410).

Based at least in part on the dimensions and force vectors of the leak 304, the segmented device 200 determines the criticality of the leak 304 at a criticality step 408 and the segmented device 200 identifies if an appropriate vacuum cap 230 suction force to stop the leak 304 based on the dimensions and force of the leak at step 410. In addition, at step 410, the segmented device 200 determines if the segmented device 200 is able to generate sufficient counter force using the vacuum cap 230.

Next, the segmented device 200 aligns the vacuum cap 230 with the leak 304 in an alignments step 412 and applies the appropriate amount of suction to seal the leak 304 in an apply suction step 414.

After applying the suction, the segmented device 200 determines if the amount of applied suction is sufficient to prevent the leak 304 in a determine if additional force is required step 416.

When the suction generated by the vacuum cap 230 is not sufficient on its own, the segmented device 200 determines if a constriction force is able to be generated and supplement the suction forces in a constriction force step 416. Initially, the segmented device 200 determines how long (L) the segmented device 200 is and identifies material properties of the vacuum cap 230 which is attached at the bottom side of the segmented device 200. In addition, the segmented device 200 identified material properties of the pipe 302 and the material of the flexible membrane 238 to determine a coefficient of friction (μ). As the segmented device 200 traverses the pipe 302 to the leak 304, sensors in the sensor suite 340 monitor the traversal and identify a slip factor (s) of the pipe 302 in real time. The slip factor (s) is the reduction in friction resulting from the fluid leaking through the leak 304.

In addition, as the segmented device moves along the pipe 302, the segmented device 200 calculates or verifies a circumference (C) of the pipe 302 and a radius of the pipe 302 according to C = 2 × π × r, where r is the radius. Using this information, the segmented device 200 identifies how many times the device 200 can wrap around the pipe 302 according to n = L / (= 2 × π × r ).

Once a number of wrappings (n) has been determined, the segmented device 200 identifies a total constriction force that can be calculated according to Force (FS) = Tension (T) × Coefficient of Friction (μ) x slip factor (s) x Number of available wrappings around the pipe (n), where F represents the force generated in the wrapping of the segmented device 200, T is the tension in the segmented device 200 while creating the wrapping, μ is the coefficient of friction between the segmented device 200 and the surface of the pipe 302, and s is the slip factor.

The force F is determined by measuring the tension in the segmented device 200 during wrapping or during a design process. The tension in the segmented device 200 depends on various factors such as the wrapping force, the angle at which the segmented device 200 constricts, friction, and the like. The coefficient of friction represents the interaction between the segmented device 200 lower surface and the surface of the pipe 302. The coefficient of friction depends on the nature of the materials involved and can be determined experimentally or based on known values for specific materials. The tension (T) is multiplied by the coefficient of friction (μ) to calculate the force (F) generated in the wrapping knot. Slip factor (s) is applied because of the fluid on the pipe surface reduces the coefficient of friction (μ), and number of wrappings created by the segmented device 200 on the body of the pipe 302 multiples the force generated by each wrapping.

When the available constriction force in combination with the suction force of the vacuum cap 230 is sufficient to stem the leak 304, the segmented device 200 wraps around the pipe and constricts in a constriction step 418. After constricting the segmented device 200 remains in place until a full repair technician is able to safely approach the pipe 302 and provide a permanent fix. In some examples, when a length of the segmented device 200 is sufficient, a portion of the segmented device 200 not required to maintain the constriction force may detach at one of the joints 212, 214 and return to a base of operations, leaving a constricting portion of the segmented device 200 behind to seal the leak 304.

While described above within the general context of a pipe, or similar feature, it is appreciated that the segmented device 200 may apply the vacuum cap 230 sealing to any crack or surface which can be traversed by the segmented device and is not limited to pipes and other features that can be constricted.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A device comprising:
a plurality of segments interconnected via a plurality of articulating joints;
at least one segment of the plurality of segments including a vacuum cap, the vacuum cap comprising a curved sheet of a first flexible material, a flexible membrane, a region defined between the curved sheet of the first flexible material and the flexible membrane, and a pump configured to evacuate the region; and
a controller controllably coupled to the plurality of segments and the pump, the controller configured to navigate the device to a leak, position the vacuum cap on the leak and engage the vacuum cap.

2. The device of claim 1, wherein the controller is disposed on a segment of the plurality of segments.

3. The device of claim 1, wherein the controller is remote from the plurality of segments and in wireless communication with the plurality of segments.

4. The device of claim 1, wherein the controller is further configured to identify a leak force and respond to the leak force exceeding an available vacuum force of the vacuum cap by constricting the plurality of segments about a component including the leak thereby adding a constricting force to the available vacuum force.

5. The device of claim 1, wherein multiple segments of the plurality of segments include corresponding vacuum caps.

6. The device of claim 5, wherein distinct segments of the plurality of segments include distinct vacuum cap configurations, with the distinct vacuum cap configurations defining varying dimensions and vacuum forces.

7. The device of claim 1, wherein the controller is in communication with a plurality of sensors and wherein the controller includes a machine learning based leak detection algorithm configured to receive sensor readings from the plurality of sensors and identify a leak.

8. The device of claim 7, wherein at least a subset of the sensors are sensors withing a suite of sensors disposed on the device.

9. The device of claim 7, wherein at least a subset of the sensors are distributed about an environment including the leak and are in communication with the controller via a network connection.

10. A method comprising:
dispatching a segmented device, the segmented device including a plurality of segments interconnected via a plurality of articulating joints, at least one segment of the plurality of segments including a vacuum cap, the vacuum cap comprising a curved sheet of a first flexible material, a flexible membrane, a region defined between the curved sheet of the first flexible material and the flexible membrane, and a pump configured to evacuate the region, and a controller controllably coupled to the plurality of segments and the pump and to a plurality of sensors, the controller configured to navigate the device to a leak, position the vacuum cap on the leak and engage the vacuum cap;
navigating the segmented device about an environment and detecting a leak using the controller; and
positioning the vacuum cap over the leak and engaging the vacuum cap, thereby sealing the leak.

11. The method of claim 10, wherein positioning the vacuum cap over the leak and engaging the vacuum cap further comprises determining a leak force of the leak, comparing the leak force of the leak to an available vacuum force of the vacuum cap and responding to the leak force exceeding the available vacuum force of the vacuum cap by constricting the segmented device about a structure including the leak thereby supplementing the vacuum force with a constriction force.

12. The method of claim 11, wherein constricting the segmented device about the structure includes determining an available constriction force according to constriction Force (FS) = Tension (T) × Coefficient of Friction (μ) x slip factor (s) x Number of available wrappings around a pipe (n), where F is a force generated by wrapping of the segmented device about the structure, T is a tension in the segmented device, μ is a coefficient of friction between the segmented device and a surface of the structure, and s is a slip factor.

13. The method of claim 10, further comprising responding to detecting a leak by determining opening dimensions of the leak and a leakage force of fluid exiting the opening based on an output of the plurality of sensors.

14. The method of claim 13, wherein determining the leakage force according to F = P*A, where F is the leakage force, P is a pressure of a leaking fluid and A is an area of the leak, and wherein determining the leakage force comprises computing a single resultant force vector using on a plurality fluid vectors.

15. The method of claim 10, wherein the plurality of sensors includes a subset of sensors disposed about an environment and remote from the segmented device.

16. The method of claim 10, wherein the plurality of sensors includes a set of sensors disposed in a sensor suite on the segmented device.

17. The method of claim 10, wherein the controller is remote from the segmented device and is in communication with the segmented device via a wide area network.

18. The method of claim 10, wherein the controller is disposed on the segmented device.

19. The method of claim 10, further comprising disconnecting a subset of segments from the segment including the engaged vacuum cap and navigating the subset of segments to a base of operations while the segment including the engaged vacuum cap remains at the leak.

20. The method of claim 10, wherein positioning the vacuum cap over the leak and engaging the vacuum cap, thereby sealing the leak comprises identifying a segment including an vacuum cap at least as large as the leak and positioning the identified segment over the leak.
